(19) United States
(12) Patent Application Publication
(10) Pub. No.: US 2023/0100260 A1
(43) Pub. Date: Mar. 30, 2023

(54) SYSTEM AND METHOD FOR PROVIDING INFORMATION BASED ON GEOGRAPHIC PARAMETERS

(71) Applicants: Jeffrey S Meyers, San Diego, CA (US); Kent Mouton, Beverly Hills, CA (US); Barry Schlesinger, Beverly Hills, CA (US)

(72) Inventors: Jeffrey S Meyers, San Diego, CA (US); Kent Mouton, Beverly Hills, CA (US); Barry Schlesinger, Beverly Hills, CA (US)

(21) Appl. No.: 18/077,545

(22) Filed: Dec. 8, 2022

Related U.S. Application Data
(63) Continuation of application No. 17/013,781, filed on Sep. 7, 2020.
Application No. 17/013,781 is a continuation of application No. 16/141,581, filed on Sep. 25, 2018, now abandoned.
Application No. 16/141,581 is a continuation of application No. 14/150,109, filed on Jan. 8, 2014, now abandoned.
(60) Provisional application No. 61/750,561, filed on Jan. 9, 2013.

(51) Int. Cl. G06Q 50/16; G09B 29/10; H04H 20/59; H04H 60/52; H04H 60/63; G09B 29/00; G06F 16/9537; G06Q 30/02; G06Q 30/06

(52) U.S. Cl. CPC G06Q 50/16; G06F 16/9537; G06Q 30/0205; G06Q 30/0623; G09B 29/007; G09B 29/10; H04H 20/59; H04H 60/52; H04H 60/63

(57) ABSTRACT

A method for providing information based on geographic parameters is disclosed. The method includes providing a map. A user-defined position on the map is received. Data of a first type, wherein the first type data relates to the user-defined position on the map, is provided.

### CROSS-REFERENCE TO RELATED APPLICATION

This application is a continuation of U.S. Non-Provisional Utility Application Serial No. 17/013,781 filed Sep. 07, 2020, which is a continuation of U.S. Non-Provisional Utility Application Serial No. 16/141,581 filed Sep. 25, 2018, which is a continuation of U.S. Non-Provisional Utility Application Serial No. 14/150,109 filed Jan. 8, 2014, which claimed priority under 35 U.S.C. § 119(e) to U.S. Provisional Utility Application Serial No. 61/750,561 filed Jan. 9, 2013, the contents of which are all fully incorporated by this reference.

### BACKGROUND OF INVENTION

This application relates generally to relating information or data to geographic regions. More specifically, this application relates systems and methods for providing information based on geographic parameters.

### SUMMARY

In purchasing, selling, developing or otherwise making decisions about real estate, it is important to have as much information about the surrounding area as possible. This is because the value of the real estate under consideration depends not only on the characteristics of the real estate itself but also characteristics of the surrounding area (e.g. schools, crime rates, employment rates, property values of neighboring areas, etc.). Obtaining the relevant information or data about a particular geographic region frequently involves consulting a plurality of sources. It would be much more efficient and cost effective to retrieve from fewer sources and provide the information in a quick and easy to comprehend format.

In one embodiment, a method for providing information based on geographic parameters comprises: providing a map; receiving a user-defined position on the map; and providing data of a first type, wherein the first type data relates to the user-defined position on the map.

In another embodiment, a system for providing information based on geographic parameters comprises: one or more participant terminals operable to act as a client on a network; a computer operable to act as a server on the network and to communicate with each of the participant terminals over the network, the computer comprising: a memory configured to store a set of instructions; and a processor configured to execute the set of instructions, wherein the set of instructions cause the processor to: provide a map for display at one or more of the one or more terminals; receive a user-defined position on the map; and providing data at one or more of the one or more terminals, wherein the data relates to the user-defined position on the map.

### BRIEF DESCRIPTION OF THE DRAWINGS

The drawings, when considered in connection with the following description, are presented for the purpose of facilitating an understanding of the subject matter sought to be protected.

FIG. 1 illustrates a system of the present disclosure;

FIG. 2 illustrates a method of the present disclosure;

FIG. 3 is an illustrative map;

FIG. 4 is an illustrative map showing a user-defined position;

FIG. 5a is an illustrative screen shot;

FIG. 5b is a second illustrative screen shot;

FIG. 6 is an illustrative map having an intensity map; and

FIG. 7 is another method of the present disclosure.

### DETAILED DESCRIPTION

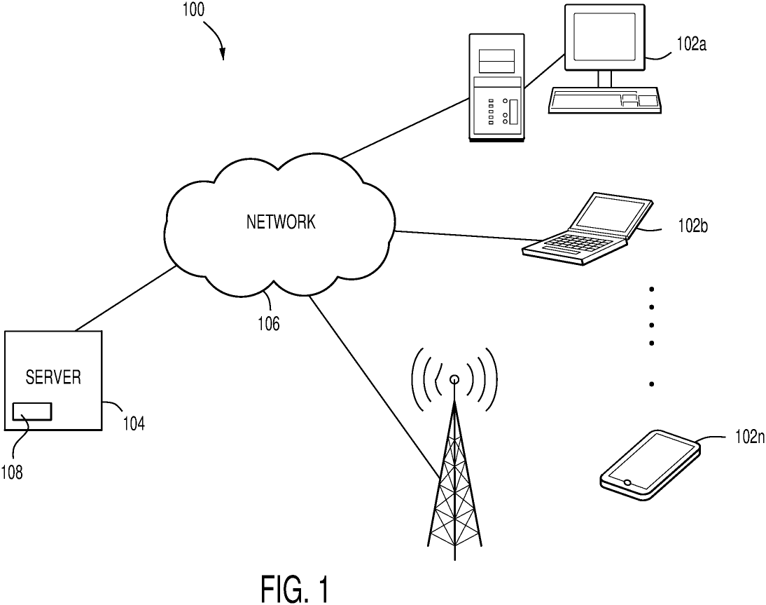

Referring now to FIG. 1, a system 100 for providing information or data based on geographic parameters is depicted. The system 100 may include one or more terminals 102a-102n (collectively 102), a server 104, and a communications network 106. The different elements and components of the system 100 may communicate with one another using wireless communications or hardwired connections, such as fiber optics, cable, DSL, telephone lines, and other similar connections.

The communications network 106 may include any number of networks capable of providing communications between the server 104 and terminals 102. For example, the communications network may be one or more, or any combination of, wireless networks, data or packet networks, publicly switched telephone networks (PSTN), etc.

The participant terminals 102 may include any suitable device operable to act as a client on a network. Illustrative terminals 102 include, but are not limited to, personal computers, desktop computers, laptop computers, servers, or any suitable telecommunications device, including, but not limited to, VoIP telephones, smart telephones or wireless devices, such as cellular telephones, personal digital assistants (PDA), communications enabled mp3 players, etc. Each terminal 102 may be configured to transmit and/or receive information to and/or from the server 104 and/or other participant terminals 102.

The server 104 may be any server, computer or device configured to process commands from the participant terminals 102. In the illustrative embodiment, the server 104 includes a memory and a processor to accommodate the following. However, it will be appreciated that the following may be implemented in hardware, software, or a suitable combination of hardware and software, and which can be one or more software systems operating on a general purpose server platform. As used herein, a hardware system can include discrete semiconductor devices, an application-specific integrated circuit, a field programmable gate array or other suitable devices. A software system can include one or more objects, agents, threads, lines of code, subroutines, separate software applications, user-readable (source) code, machine-readable (object) code, two or more lines of code in two or more corresponding software applications, databases, or other suitable software architectures. In one exemplary embodiment, a software system can include one or more lines of code in a general purpose software application, such as an operating system, and one or more lines of code in a specific purpose software application.

One or more databases 108 may be in communication with the server 102. The database(s) 108 are configured to store information or data relating to geographic parameters for access by the server 104 and/or terminals 102. Any such suitable information or data, or data type, may be stored on the one or more databases 108. Illustrative geographic-related information or data includes, without limitation, economic data, community data, sales data, supply data, price data, and distress data. As used herein, economic data includes, without limitation, real GDP, consumer confidence, inflation (core and full), job growth, private job growth, unemployment rate, productivity jobless claims, 30-year fixed mortgage rate, adjustment mortgage rates, 10 year treasury, housing market/builder sentiment, leading economic indicators, Dow Jones Industrial Average, S&P 500, NASDAQ, S&P Super Homebuilding, public home builder stock, real GSP, jobs by sector, personal income growth, mass layoffs, real county product, top employers, job openings, job density, office absorption, etc. As used herein, community data includes, without limitation, population, household information, home ownership rate, renter households, household income, population by age, debt to income ratio, walkability, school information, crime rates, ethnicity information, etc. As used herein, sales data includes, without limitation, existing home sales, purchase mortgage applications, new home sales, public builder new home orders, mortgage originations, existing home sales, sales by type, foreclosure sales, investor sales, etc. As used herein, supply data includes, without limitation, months of resale inventory, months of new home inventory, total building permits, E/P ratio, total housing starts, housing vacancies, days on market, number of listings, months of inventory, etc. As used herein, price information includes, without limitation, existing home prices, resale affordability, new home prices, new home affordability, Case Shiller Index, prices by type, prices to rent, etc. As used herein, distress data includes, without limitation, number of foreclosures, % of loans in foreclosure, mortgage delinquencies, foreclosure sales, notices of default, etc. The one or more databases may include any of the geographic-related data a various geographic levels. For example, without limitation, suitable geographic levels may include national, state, province, county, city, zip code, site, etc. It will be appreciated that the database may include any suitable information, data or data type and that the forgoing is illustrative only and not to be construed as limiting in any way.

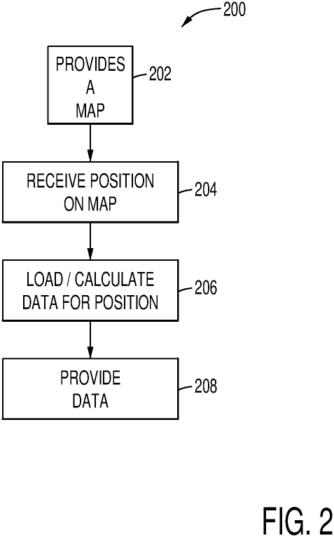

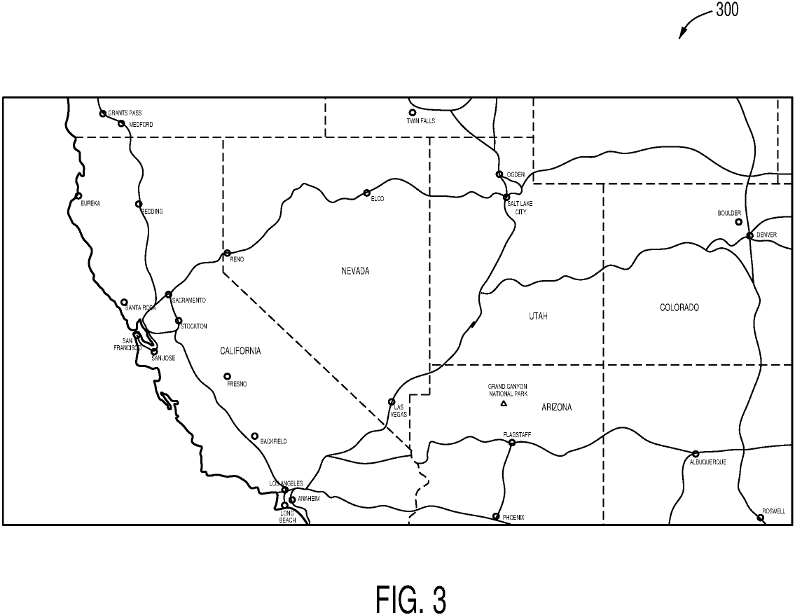

Referring now to FIG. 2, a method 200 for providing information or data based on geographic parameters is depicted. First, a map is provided to a user device or terminal [step 202]. FIG. 3 is a non-limiting illustrative example of a such a map 300. The map 300 may be at any suitable level (e.g. global, national, state, county, city, zip code, user-defined, etc.). Also, the map may be manipulated by a user such that the user may zoom-in on portions of the map or, alternatively, zoom out of portions of the map such that a user may identify the appropriate level of the map and locate a desired position on the map.

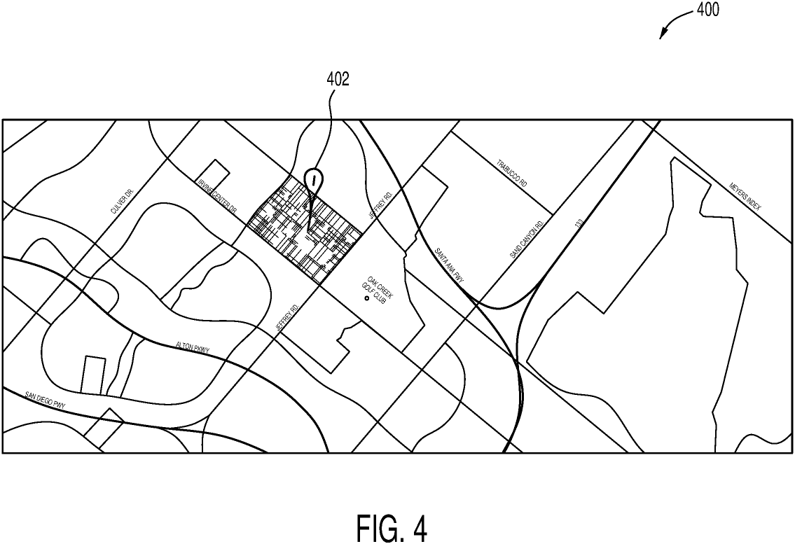

Next, a user-defined position on the map is received [step 204]. FIG. 4 is a non-limiting illustrative example of a user-defined position 402 on a map 400. A user may define the position on the map in any suitable way. For example, and without limitation, a map may be displayed on a user’s device/terminal which has a touch screen and the user may touch or outline the user-defined position on the map with the user’s finger. However, it will be appreciated that any suitable input means may be employed including, without limitation, by way of a stylus on a touchscreen, stylus on a touchpad, a computer mouse or touchpad, a keyboard, inputting GPS coordinates via any suitable means, inputting latitude and longitude coordinates via any suitable means, or any other suitable means for communicating data by way of and to any suitable data processing or data handling device.

Information or data relative to the user-defined position may then be loaded, retrieved or calculated [step 206]. In one non-limiting example, since the user-defined position may include one or more traditional geographic regions (e.g. national, state, county, city, zip, etc.), or portions thereof, it may be necessary to compile and mathematically manipulate (e.g. average, median, etc.) the data for those regions so as to provide a more comprehensive result set. It will be appreciated that such calculating is optional and embodiments without such calculations are contemplated and encompassed herein. For example, and without limitation, if the user-defined position is a particular point or pin on the map, such calculations may not be necessary or relevant; although, in some instance they still may be. The information or data may be strictly related to the user-defined area or may also include data relevant to a larger geographic area in which the user-defined area resides. For example and without limitation, if the user-defined position is a region within defined city limits, relevant data may include not only data specific to the user-defined position within the city but also any other larger geographic region in which the user-defined area resides - zip code, city, county, state, national, etc. This may, for example, allow the user to understand the information or data relative to the user-defined position in a greater context (e.g. a comparison of the unemployment rate within the user-defined area to the state or national average, etc.). The type of data loaded, retrieved or calculated may be predetermined by the user prior to defining a position on the map, may be selected by the user after the user-defined position placed on the map, predetermined by the system or an administrator or at any other suitable time.

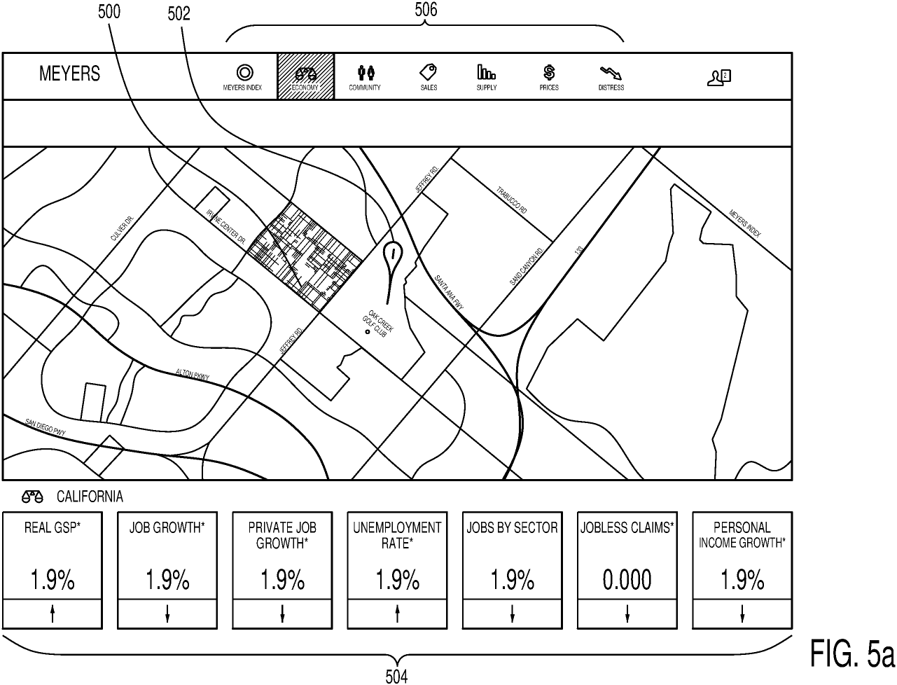

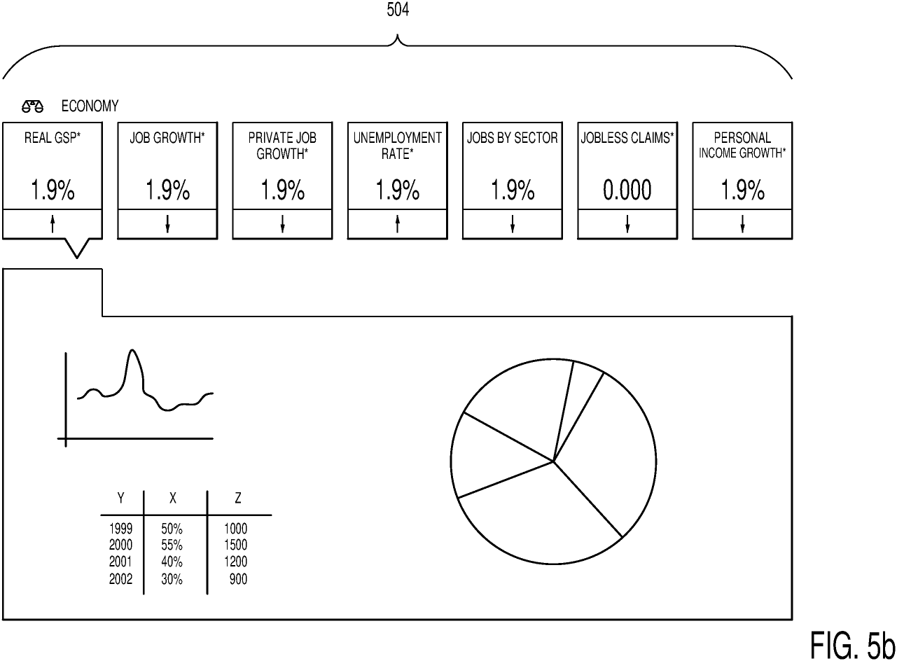

The data may then be provided to the user [step 208]. The data may be provided to the user via any suitable means or in any suitable form. For example, the data may be provided in the form chart(s), graph(s), table(s), spreadsheet(s), down-loadable files, or any combination thereof. FIGS. 5a-5b depict an illustrative example of displaying data relevant to the user-defined position, which would typically be seen on a user’s device or terminal. As best shown in FIG. 5a, data relevant to a particular data type may be provided adjacent to the map 500 by way of a series of “cards” 504. Also, access to different data types may be provided adjacent to the map 500 via one or more buttons 506. As shown in FIG. 5b, a user may select a particular card 504 relating to a particular data type 506 for access to additional information related to the data represented by the card 504. This additional information may be in any suitable form including, but not limited to, chart(s), graph(s), table(s), spreadsheet(s), down-loadable files, video files, image files, audio files, or any combination thereof. The user may click on the card a second time to close the screen providing this additional information.

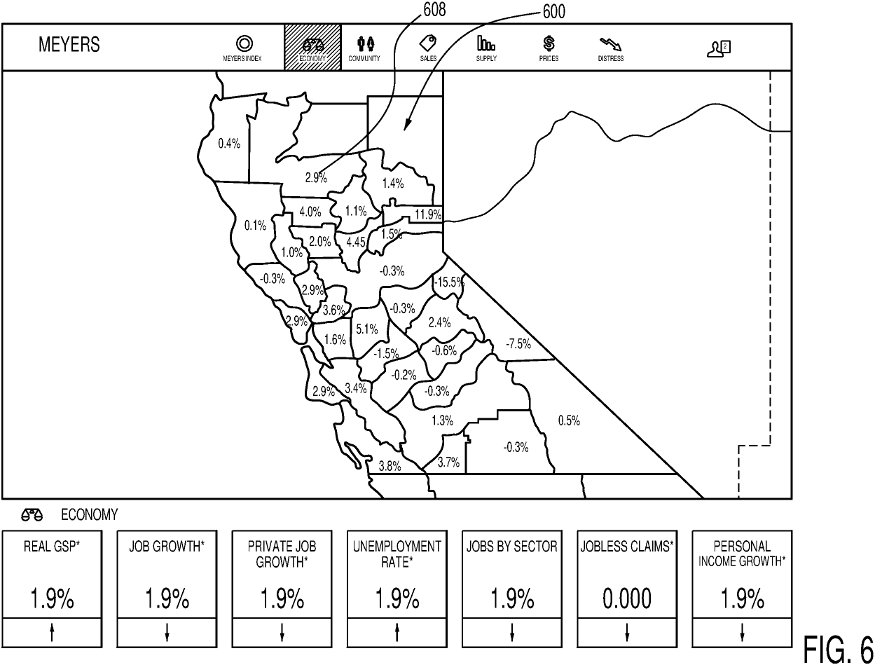

In another embodiment, as shown in FIG. 6, the information or data may be displayed as an intensity map 608 overlaying the map 600. As used herein, the term “overlay” refers to additional data being provided on the map and is to be understood broadly and is not limited to encompassing a first map being placed atop or adjacent a second map. It will be understood an intensity map is a map that displays the weight, value, frequency, density, or any other metric for one portion of the map relative to other portion(s) of the map. In the example of FIG. 6, the intensity map uses numerical values for this, but any suitable means for showing how one portion of a map compares to other portion(s) will be sufficient. For example, in one embodiment, a color scheme may be employed where certain colors representing “hotter” areas (e.g. areas with a greater density, frequency, etc.) and “cooler” areas (e.g. areas with a lesser density, frequency, etc.) may be used rather than strict numerical values. In another embodiment, a shading or pattern scheme is used similarly. Other means will now be apparent to those skilled in the art and are contemplated herein. It will be appreciated that the forgoing includes examples for illustrative purposes and that the information or data may be provided to the user in any suitable form or combination and remain within the scope of the present disclosure.

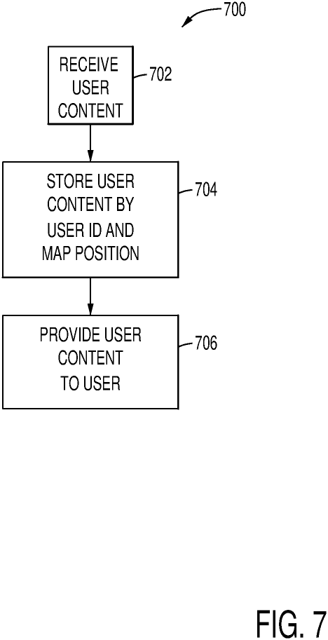

Additional features may also be provided. For example, in one embodiment, a user may create and/or communicate information or content from a user’s device/terminal to the server for access by the user at a later time. As best shown in the method 700 FIG. 7, the server may receive user content [step 702] and store the user content by user ID and/or user-identified map position [step 704]. The content may then be accessed later by the user [step 706]. The user content or information may have any suitable form. For example, the user content or information may be one or more images, videos, text files, position(s) on the map, screen shots, or any other suitable content or information. This user content or information may be later accessed by the user. Alternatively, the user content may be accessed by the user as well as other users.

While the present disclosure has been described in connection with what is considered the most practical and preferred embodiment, it is understood that this disclosure is not limited to the disclosed embodiments, but is intended to cover various arrangements included within the spirit and scope of the broadest interpretation so as to encompass all such modifications and equivalent arrangements.

What is claimed is:

1. A method for providing economic information based on geographic parameters comprising:
providing a map for display on a computing device;
receiving a first user-defined position on the map; and
providing data of a first type, wherein the first type data relates to the user-defined position on the map, and wherein the data provided is selected from the group consisting of economic data, community data, sales data, supply data, price data, and distress data, and;
providing data of a second type in the first user-defined position selected by the user, wherein the user data provided is selected from the group consisting of economic data, community data, sales data, supply data, price data, and distress data, and wherein the user was provided with the first data and the second data without the user having to redefine said first user-defined position on the map.

2. The method of claim 1 wherein the data is displayed adjacent to the map.

3. The method of claim 1 wherein the data includes data relating to one or more geographic positions, wherein the one or more geographic positions includes at least one of a nation, a state, a county, a city or a zip code.

4. The method of claim 1 wherein the data is displayed as an intensity map overlaying the map.

5. A system for providing economic information based on geographic parameters comprising:
one or more participant terminals operable to act as a client on a network;
a computer operable to act as a server on the network and to communicate with each of the participant terminals over the network, the computer device comprising:
a memory configured to store a set of instructions; and
a processor configured to execute the set of instructions, wherein the set of instructions cause the processor to:
provide a map for display at one or more of the one or more terminals;
receive a user-defined position on the map;
provide data of a first type at one or more of the one or more terminals, wherein the data relates to the user-defined position on the map, wherein the user data provided is selected from the group consisting of economic data, community data, sales data, supply data, price data, and distress data and wherein the data provided can be either selected by the user before defining the user-defined position or after defining the user-defined position; and,
provide data of a second type in the first user-defined position selected by the user, wherein the user data provided is selected from the group consisting of economic data, community data, sales data, supply data, price data, and distress data, and wherein the user was provided with the first data and the second data without the user having to redefine said first user-defined position on the map.

6. The system of claim 5 wherein the data is displayed adjacent to the map.

7. The system of claim 5 wherein the data is displayed on the map.

8. The system of claim 5 wherein the data is displayed as an intensity map overlaying the map.

9. The system of claim 5 wherein user generated information is communicated to the server by one or more terminals of the one or more terminals.

10. The system of claim 5 wherein the data of the second type relates to a larger geographic area that encompasses the user-defined position on the map.

11. A system for providing information based on geographic parameters comprising:
one or more participant terminals operable to act as a client on a network;
a computer operable to act as a server on the network and to communicate with each of the participant terminals over the network, the computer comprising:
a memory configured to store a set of instructions; and
a processor configured to execute the set of instructions, wherein the set of instructions cause the processor to:
provide a map for display at one or more of the one or more terminals;
receive a user-defined position on the map; and
provide data of a first type at one or more of the one or more terminals, wherein the data relates to the user-defined position on the map, and wherein the data provided can be either selected by the user before defining the user-defined position or after defining the user-defined position.

12. The system of claim 11 wherein the data is displayed adjacent to the map.

13. The system of claim 11 wherein the data is displayed on the map.

14. The system of claim 11 wherein the data is displayed as an intensity map overlaying the map.

15. The method of claim 11 further comprising the step of providing data of a second type in response to a user request for data of a second type.

16. The method of claim 15 wherein the data of the second type relates to a larger geographic area that encompasses the user-defined position on the map.
